(19) United States
(12) Patent Application Publication
(10) Pub. No.: US 2012/0218169 A1
(43) Pub. Date: Aug. 30, 2012

(54) Antenna arrangement apparatus, reception apparatus and method reducing a common mode interference signal

(76) Inventor: Jan Johannes Maria Van Den Elzen, Gemert (NL)

(21) Appl. No.: 13/383,262

(22) PCT Filed: Jul. 10, 2009
(86) PCT No.: PCT/EP2009/058834

§ 371 Date: Apr. 27, 2012

(51) Int. Cl. H01Q 1/50

(52) U.S. Cl. 343/905

(57) ABSTRACT

An antenna arrangement apparatus (162) comprises a reception antenna (204, 210), a common-mode filter (188), and a length of separating cable (170) coupled to the reception antenna (204, 210). The length of separating cable (170) has a proximal end (180) with respect to the reception antenna (204, 210). The proximal end (180) is coupled to the reception antenna (204, 210) via the common-mode filter (188), thereby distancing, when in use, the reception antenna (204, 210) from a source of electromagnetic interference.

### FIELD OF THE INVENTION

The present invention relates to an antenna arrangement apparatus of the type that, for example, is used to receive Radio Frequency signals for an electronic device, for example a navigation device or a communications device. The present invention also relates to a receiver apparatus of the type that, for example, is used to receive the Radio Frequency signals for an electronic device, for example a navigation device or a communications device. The present invention further relates to a method of reducing a common-mode interference signal, the method being of the type that, for example, is used to receive a Radio Frequency signal in the presence of a common-mode interference current generated by an external source.

### BACKGROUND TO THE INVENTION

Portable computing devices, for example Portable Navigation Devices (PNDs), which include GPS (Global Positioning System) signal reception and processing functionality are well known and are widely employed as in-car or other vehicle navigation systems.

In general terms, a modern PND comprises a processor, memory, and map data stored within said memory. The processor and memory cooperate to provide an execution environment in which a software operating system can be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include: a visual display and a speaker for audible output. Illustrative examples of input interfaces include: one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device through the display.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information can be displayed, optionally in a status bar above, below or to one side of the displayed map information, an example of the navigation information includes a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated, a simple instruction such as “turn left in 100 m” requires significant processing and analysis. As previously mentioned, user interaction with the device may be by a touch screen, or additionally or alternately by steering column mounted remote control, by voice activation or by any other suitable method.

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems, for example a Radio Data System (RDS)-Traffic Message Channel (TMC) service.

Whilst it is known for the device to perform route re-calculation in the event that a user deviates from the previously calculated route during navigation (either by accident or intentionally), a further important function provided by the device is automatic route re-calculation in the event that real-time traffic conditions dictate that an alternative route would be more expedient. The device is suitably enabled to recognize such conditions automatically, or if a user actively causes the device to perform route re-calculation for any reason.

It is also known to allow a route to be calculated with user defined criteria for example, the user may wish to avoid any roads on which traffic congestion is likely, expected or currently prevailing. The device software would then calculate various routes using stored information indicative of prevailing traffic conditions on particular roads, and order the calculated routes in terms of level of likely congestion or delay on account thereof. Other traffic information-based route calculation and navigation criteria are also possible.

Hence, it can be seen that traffic related information is of particular use when calculating routes and directing a user to a location. In this respect, and as mentioned above, it is known to broadcast traffic-related information using the RDS-TMC facility supported by some broadcasters. In the UK, for example, one known traffic-related information service is broadcast using the frequencies allocated to the station known as “Classic fm”. The skilled person should, of course, appreciate that different frequencies are used by different traffic-related information service providers.

It is also known to provide a PND with an RDS-TMC receiver for receiving RDS data broadcast, decoding the RDS data broadcast and extracting TMC data included in the RDS data broadcast. Such Frequency Modulation (FM) receivers need to be sensitive. For many PNDs currently sold, an accessory is provided comprising an RDS-TMC tuner coupled to an antenna at one end and a connector at another end thereof for coupling the RDS-TMC tuner to an input of the PND.

In order to manufacture the antenna in a manner that is economic whilst adhering to national or regional compliance rules, for example those associated with so-called “CE marking”, it is known to form the antenna from a straight wire. However, the straight wire type antenna is susceptible to EMC interference from neighbouring electrical and/or electronic devices, for example the PND and/or a power supply, for example a Cigarette Lighter Adaptor (CLA). In this respect, unlike electronic systems integrated into a vehicle, for example an automobile, the PND is “floating” with respect to ground at Radio Frequencies and so received signals are not referenced to an “EMI clean” body of the vehicle, but to a “noisy” ground reference of the PND instead. Furthermore, it is undesirable, from the perspective of a manufacturer of a PND, to require a user of the PND to connect an antenna to the body of the vehicle in order to obtain the desired “clean” ground reference. The antenna is therefore positioned very close to the EMI “noisy” PND. Consequently, antenna performance can, in some circumstances, be inadequate resulting in the PND not receiving any data or only partial data. From the perspective of a user of the PND, the user simply perceives that no or incomplete traffic information is available and can wrongly conclude that the PND and/or the TMC accessory are/is malfunctioning.

European patent publication no. EP 1 672 787 relates to a broadcast receiver having an antenna socket coupled to a common mode input filter of a radio tuner via a feeder line. However, the input filter requires a ground, which is provided by the radio tuner. An interference-free analogue to the ground is not, unfortunately, available in the context of the RDS-TMC tuner and antenna.

Other solutions to reduce influence of externally interfering sources of Radio Frequency (RF) signals are known. For example, external sources capable of emitting electromagnetic radiation can be shielded in respect of certain frequency ranges. However, such solutions are expensive and can result in other problems relating to, for example, heat dissipation. Additionally, when circuit designs change, provisions made for electromagnetic shielding can require modification too. Hence, design and implementation costs and lack of re-usability of an electromagnetic radiation shielding solution makes electromagnetic shielding of the external sources of electromagnetic radiations undesirable.

It should also be mentioned that, although the route calculation and navigation functions are fundamental to the overall utility of PNDs, it is possible to use the device purely for information display, or “free-driving”, in which only map and traffic information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 920 GO model manufactured and supplied by TomTom International B.V., provide a reliable means for enabling users to navigate from one position to another, in particular using traffic-related information. Such devices are of great utility when the user is not familiar with the route to the destination to which they are navigating.

### SUMMARY OF THE INVENTION

According to a first aspect of the present invention, there is provided an antenna arrangement apparatus an antenna arrangement apparatus comprising: a reception antenna; a common-mode filter; and a length of separating cable coupled to the reception antenna; wherein the length of separating cable has a proximal end with respect to the reception antenna, the proximal end being coupled to the reception antenna via the common-mode filter, thereby distancing, when in use, the reception antenna from a source of electromagnetic interference.

For the avoidance of doubt, it should be appreciated that references herein to “a length of coaxial cable” and “the length of coaxial cable” are intended to be distinct from references to “a length of the coaxial cable” and “the length of the coaxial cable”. In this respect, references to the length of coaxial cable are intended to refer to a portion of coaxial cable of unspecified length. Of course, example lengths may be specified herein as well. Indeed, reference to the length of the coaxial cable is an abbreviation of “the length of the length of coaxial cable” and is intended to refer to physical length.

The separating cable may be a coaxial cable.

The reception antenna may comprise a length of coaxial cable constituting a feedline portion; the length of coaxial cable may be coupled at a first end thereof to a pole portion.

The separating cable may constitute a supplemental feedline portion.

The feedline portion may be coupled at a second end thereof to the length of separating cable via the common-mode filter.

The feedline portion coupled to the supplemental feedline portion via the common-mode filter may constitute an antenna feedline.

The reception antenna may be a resonant feedline dipole reception antenna having a first pole portion constituting the pole portion and the length of coaxial cable constituting the feedline portion; the length of coaxial cable may also provide a second pole portion.

A length of the first pole portion may correspond to about a quarter of a predetermined wavelength for a Radio-Frequency (RF) signal to be received.

A length of the second pole portion may correspond to between about a third of a predetermined wavelength and about a quarter of the predetermined wavelength for a Radio-Frequency (RF) signal to be received.

The apparatus may further comprise a length of uniaxial electrical conductor serving as the first pole portion.

The length of coaxial cable may comprise a shield; the shield may serve as the second pole portion.

The separating cable may have a distal end with respect to the reception antenna; the distal end of the separating cable may be compatible for coupling to a tuner.

The common-mode filter may have a common-mode impedance of between about 1000 Ω and about 4000 Ω. The common-mode filter may have a common mode impedance of about 2200 Ω.

The separating cable may be at least about 5 cm in length. The separating cable may be less than about 30 cm in length.

The common-mode filter may be a bifilar coil.

The apparatus may further comprise a housing comprising the common-mode filter disposed therein. The housing may be an encapsulation.

A first side of the common-mode filter may be coupled to the reception antenna via a first bridging connector and a second bridging connector so as to form substantially a loop having a loop area; the loop area may be sized to minimise electromagnetic interference.

The surface area of the loop area may be less than about 5 mm², for example less than about 3 mm².

According to a second aspect of the present invention, there is provided a reception apparatus a comprising: the antenna arrangement apparatus as set forth above in relation to the first aspect of the invention; and a tuner coupled to a distal end of the separating cable.

The tuner may be a Frequency Modulation (FM) tuner. The tuner may be a Radio Data System (RDS)—Traffic Message Channel (TMC) tuner.

The apparatus may further comprise a coupling cable for communicating data decoded by the tuner to a device.

According to a third aspect of the present invention, there is provided a portable navigation device comprising the antenna arrangement apparatus as set forth above in relation to the first aspect of the invention or the reception apparatus as set forth above in relation to the second aspect of the invention.

According to a fourth aspect of the present invention, there is provided a method of reducing a common-mode interference signal in respect of an antenna arrangement apparatus, the method comprising: providing a reception antenna and a length of separating cable, the length of separating cable having a proximal end with respect to the reception antenna; and coupling the proximal end of the length of separating cable to the reception antenna via a common-mode filter, thereby distancing the reception antenna from a source of electromagnetic interference.

It is thus possible to provide an apparatus and method that are less susceptible to common-mode interference signals. Improved signal reception is thus possible, thereby resulting in improved reception of information, for example traffic-related information, such as RDS-TMC data. The structure of the antenna is also simple and economic to manufacture. The use of the common-mode filter isolates the reception antenna from any common-mode interference signals induced in a coupling cable between a tuner and a device to which the apparatus can be coupled. Improved isolation of the reception antenna from other common-mode interference signals, for example those resulting from parasitic capacitances of the device to which the apparatus can be coupled, or from power sources, can be achieved. Furthermore, whilst a galvanic connection between the antenna and a chassis of a vehicle provides favourable antenna reception performance, the apparatus and method permit simplicity and convenience of removable installation of an electronic apparatus requiring an antenna, for example in a vehicle, without the need for the galvanic connection. Additionally, the apparatus and method are not necessarily application specific and so provide a flexible solution for different RF reception applications. The improved performance provided by the method and apparatus also reduces instances of user annoyance and false enquires made to manufacturers, distributors and/or retailers concerning whether or not the apparatus is faulty.

Further advantages of these embodiments are set out hereafter, and further details and features of each of these embodiments are defined in the accompanying dependent claims and elsewhere in the following detailed description.

### BRIEF DESCRIPTION OF THE DRAWINGS

At least one embodiment of the invention will now be described, by way of example only, with reference to the accompanying drawings, in which:

FIG. 1 is a schematic illustration of components of a navigation device;

FIG. 2 is a schematic representation of an architectural stack employed by the navigation device of FIG. 1;

FIG. 3 is a schematic diagram of an arrangement for mounting and/or docking the navigation device of FIG. 1;

FIG. 4 is a schematic diagram of an antenna arrangement apparatus coupled to the navigation device of FIG. 1;

FIG. 5 is a schematic diagram of the antenna arrangement apparatus of FIG. 4 in greater detail and constituting an embodiment of the invention;

FIG. 6 is a schematic diagram of the antenna arrangement apparatus of FIG. 4 in greater detail, employing an alternative reception antenna and constituting another embodiment of the invention;

FIG. 7 is a schematic diagram of the antenna arrangement apparatus of FIG. 6 in further detail;

FIG. 8 is a schematic diagram of an alternative antenna arrangement apparatus to that of FIG. 7 and constituting another embodiment of the invention; and

FIG. 9 is a schematic diagram of a housed filter of FIGS. 4, 5 and 6.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings of the present invention are not limited to PNDs but are instead universally applicable to any type of processing device, for example but not limited to those that are configured to execute navigation software in a portable or mobile manner so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention even have utility in circumstances where a user is not seeking instructions on how to navigate from one point to another, but merely wishes to be provided with information concerning, for example, traffic. In such circumstances, the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

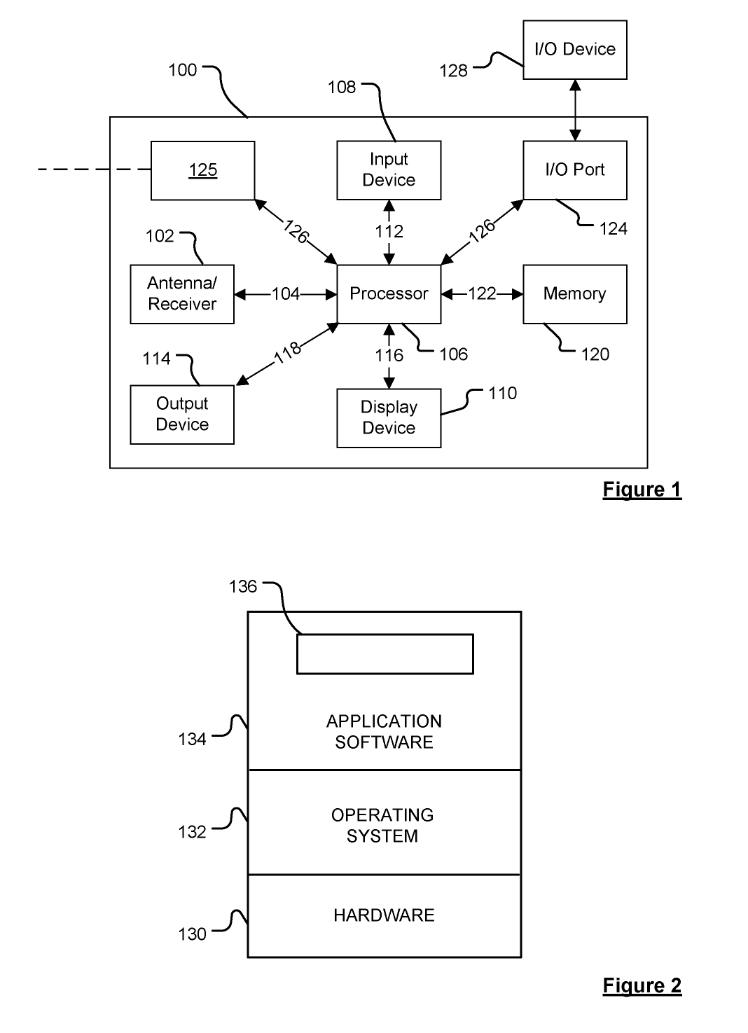

Referring to FIG. 1, a navigation device 100 is located within a housing (not shown). The navigation device 100 comprises or is coupled to a GPS receiver device 102 via a connection 104, wherein the GPS receiver device 102 can be, for example, a GPS antenna/receiver. It should be understood that the antenna and receiver designated by reference numeral 102 are combined schematically for illustration, but that the antenna and receiver may be separately located components, and that the antenna may be a GPS patch antenna or helical antenna for example.

The navigation device 100 includes a processing resource comprising, for example, a processor 106, the processor 106 being coupled to an input device 108 and a display device, for example a display screen 110. Although reference is made here to the input device 108 in the singular, the skilled person should appreciate that the input device 108 represents any number of input devices, including a keyboard device, voice input device, touch panel and/or any other known input device utilised to input information. Likewise, the display screen 110 can include any type of display screen for example a Liquid Crystal Display (LCD).

In one arrangement, one aspect of the input device 108, the touch panel, and the display screen 110 are integrated so as to provide an integrated input and display device, including a touchpad or touchscreen input to enable both input of information (via direct input, menu selection, etc.) and display of information through the touch panel screen so that a user need only touch a portion of the display screen 110 to select one of a plurality of display choices or to activate one of a plurality of virtual or “soft” buttons. In this respect, the processor 106 supports a Graphical User Interface (GUI) that operates in conjunction with the touchscreen.

In the navigation device 100, the processor 106 is operatively connected to and capable of receiving input information from input device 108 via a connection 112, and operatively connected to at least one of the display screen 110 and an output device 114, for example an audible output device (e.g. a loudspeaker), via respective output connections 116, 118. As the output device 114 can produce audible information for a user of the navigation device 100, it should equally be understood that the input device 108 can include a microphone and software for receiving input voice commands. Further, the navigation device 100 can also include any additional input device 108 and/or any additional output device, for example audio input/output devices.

The processor 106 is operatively connected to a memory resource 120 via connection 122 and is further arranged to receive/send information from/to input/output (I/O) port 124 via connection 126, wherein the I/O port 124 is connectible to an I/O device 128 external to the navigation device 100. The memory resource 120 comprises, for example, a volatile memory, such as a Random Access Memory (RAM) and a non-volatile memory, for example a digital memory, such as a flash memory.

The external I/O device 128 may include, but is not limited to, an external listening device, such as an earpiece for example. The connection to I/O device 128 can further be a wired or wireless connection to any other external device, for example a car stereo unit for hands-free operation and/or for voice activated operation, for connection to an earpiece or headphones, and/or for connection to a mobile telephone, the mobile telephone connection can be used to establish a data connection between the navigation device 100 and the Internet or any other network for example, and/or to establish a connection to a server via the Internet or some other network for example.

The navigation device 100 is capable of establishing a data session, if required, with network hardware of a “mobile” or telecommunications network via a mobile device (not shown), for example the mobile telephone described above, a PDA and/or any device with mobile telephone technology, in order to establish a digital connection, for example a digital connection via known Bluetooth technology. Thereafter, through its network service provider, the mobile device can establish a network connection (through the Internet for example) with the server (not shown). As such, a “mobile” network connection can be established between the navigation device 100 (which can be, and oftentimes is, mobile as it travels alone and/or in a vehicle) and the server to provide a “real-time” or at least very “up to date” gateway for information.

In this example, the navigation device 100 also comprises an input port 125 operatively coupled to the processor 106 for receipt of traffic-related data.

It will, of course, be understood by one of ordinary skill in the art that the electronic units schematically shown in FIG. 1 are powered by one or more power sources (not shown) in a conventional manner. As will also be understood by one of ordinary skill in the art, that different configurations of the units shown in FIG. 1 are contemplated. For example, the components shown in FIG. 1 may be in communication with one another via wired and/or wireless connections and the like. Thus, the navigation device 100 described herein can be a portable or handheld navigation device 100.

It should also be noted that the block diagram of the navigation device 100 described above is not inclusive of all components of the navigation device 100, but is only representative of many example components.

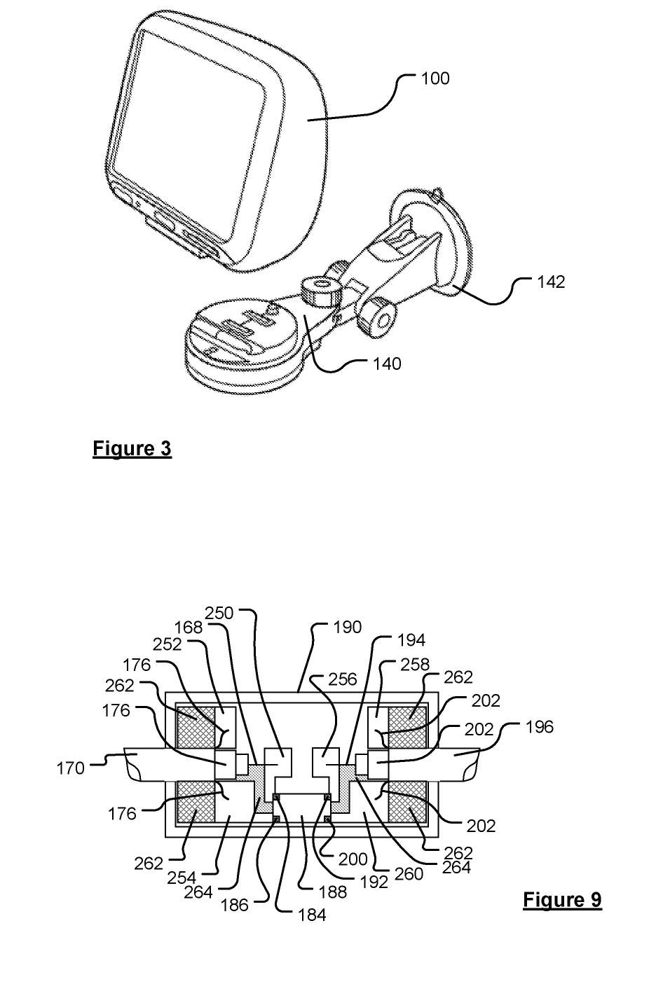

Turning to FIG. 2, the memory resource 120 of the navigation apparatus 200 stores a boot loader program (not shown) that is executed by the processor 202 in order to load an operating system 132 from the memory resource 120 for execution by functional hardware components 130, which provides an environment in which application software 134 can run. The operating system 132 serves to control the functional hardware components 130 and resides between the application software 134 and the functional hardware components 130. The application software 134 provides an operational environment including the GUI that supports core functions of the navigation apparatus 200, for example map viewing, route planning, navigation functions and any other functions associated therewith. In this example, part of the application software 134 comprises a traffic data processing module 136 that receives and processes traffic-related data and provides the user with traffic information integrated with map information. As such functionality is not, by itself, core to the embodiments described herein, no further details of the traffic data processing module 136 will be described herein for the sake of conciseness and clarity of description.

Referring to FIG. 3, the navigation device 100 is, in this example, capable of coupling to an arm 140, the arm being capable of being secured to, for example, a vehicle dashboard or window using a suction cup 142. The arm 140 is one example of a docking station with which the navigation device 100 can be docked. The navigation device 100 can be docked with, or otherwise connected to, the docking station 140 by snap connecting the navigation device 100 to the arm 140, for example. The navigation device 100 can also be rotatable on the arm 140. To release a connection between the navigation device 100 and the docking station 140, a button on the navigation device 100 is provided and can be pressed. Other equally suitable arrangements for coupling and decoupling the navigation device 100 to a docking station can alternatively be provided.

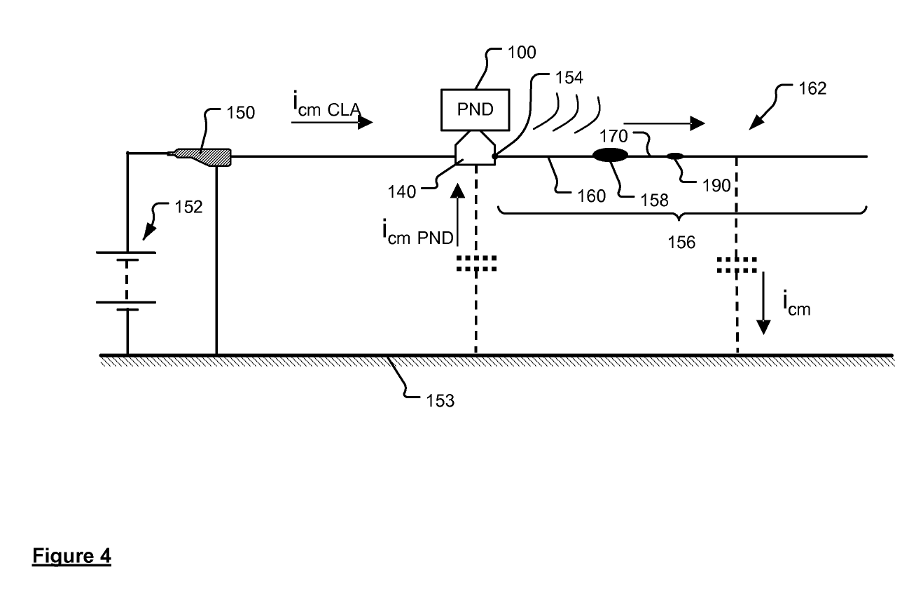

Turning to FIG. 4, the navigation device 100 is, in this example, located in a vehicle, for example an automobile, and connected to the docking station 140. The docking station 140 is coupled to a Cigarette Lighter Adaptor (CLA) 150, the CLA 150 being plugged into a so-called cigarette lighter (not shown) of the vehicle. The coupling of the CLA 150 to the cigarette lighter of the vehicle allowing a battery 152 of the vehicle to be used to power the navigation device 100, in this example via the docking station 140, after appropriate conversion of the 12V Direct Current (DC) supply provided by the battery 152. Both the battery 152 and the CLA 150 are coupled to the ground 153 provided by the vehicle, typically the chassis or body of the vehicle.

The docking station 140 comprises an input port 154 that is coupled to the input port 125 of the navigation device 100 when the navigation device 100 is docked. A reception apparatus 156 is coupled to the docking station 140. In this respect, the reception apparatus 156 comprises a coupling connector (not shown), for example a jack plug, for coupling to the input port 154, the connector being coupled to a tuner (not shown in FIG. 4), located in a housing 158, via a coupling cable 160. Of course, if the docking station 140 is not employed, the coupling connector can be directly connected to the input port 125 of the navigation device 100.

The tuner within the housing 158 is, in this example, a Frequency Modulation (FM) receiver, particularly an RDS-TMC tuner. By way of example, a suitable receiver is available from GNS GmbH, Germany. The receiver apparatus 156 also comprises the tuner and an antenna arrangement apparatus 162, the tuner being coupled to the antenna arrangement apparatus 162.

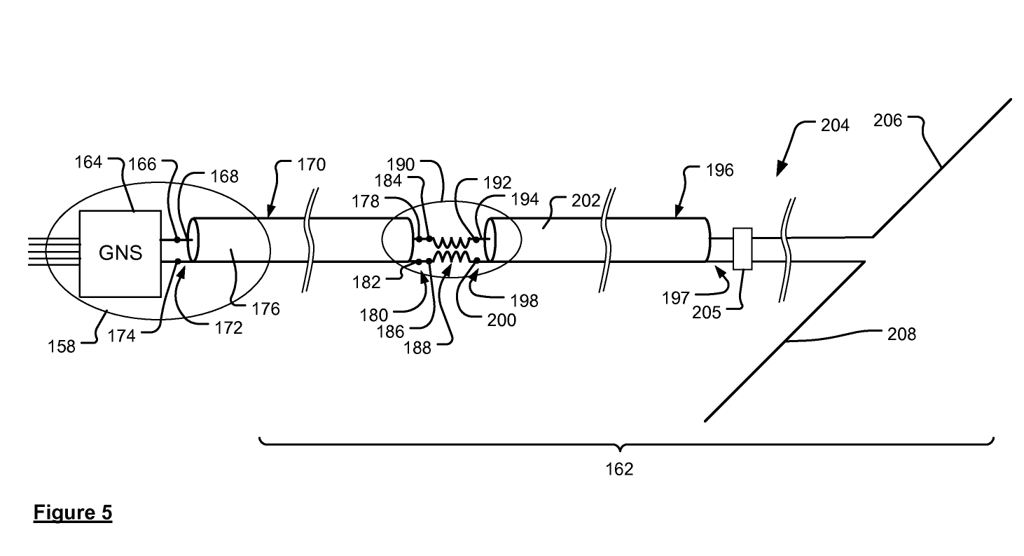

Referring to FIG. 5, the antenna arrangement apparatus 162 comprises a first length of coaxial cable 170, a filter 188 and a reception antenna 204. A distal end 172 of the first length of coaxial cable 170 is compatible for coupling to the tuner 164. The tuner 164 is therefore coupled to a first terminal 166 of a first core 168 of the first length of coaxial cable 170 at a distal end 172 thereof and a first terminal 174 of a first shield 176 at the distal end 172 of the first length of coaxial cable 170. The distal end 172 of the first length of coaxial cable 170 is with respect to the reception antenna 204 when the antenna arrangement apparatus 162 is in a deployed state. In this example, the first length of coaxial cable 170 constitutes a separating cable. A second terminal 178 of the first core 168 at a proximal end 180 of the separating cable 170 and a second terminal 182 of the first shield 176 at the proximal end 180 of the separating cable 170 are coupled to a first terminal 184 and a second terminal 186 of the filter 188, respectively. The proximal end 180 of the first length of coaxial cable 170 is with respect to the reception antenna 204 when the antenna arrangement apparatus 162 is in a deployed state. The filter 188 is a common-mode filter, for example a common-mode transformer, such as a coil, or a toroidal inductor or a common-mode choke, for example a bifilar choke. The filter 188 is located in a second housing 190 and has a common-mode impedance and a differential-mode impedance. The common-mode impedance of the filter can be at least about 1 kΩ. The common-mode impedance can be between about 1 kΩ and about 4 kΩ, for example between about 1.5 kΩ and about 2.5 kΩ, such as between about 2 kΩ and about 2.3 kΩ. In this example, the filter 188 has a common-mode impedance of about 2.2 kΩ. This is considerably in excess of an inherent common-mode impedance of a length of cable. The differential-mode impedance of the filter 188 can be between about 1 Ω and about 50 Ω, for example, between about 1 Ω and about 20 Ω, such as between about 5 Ω and about 15 Ω. In this example, the differential-mode impedance of the filter 188 is about 10 Ω.

A second length of coaxial cable 196 is provided, which has a first end 197 and a second end 198. A third terminal 192 of the filter 188 is coupled to a second core 194 of the second length of coaxial cable 196 at the second end 198 thereof and a fourth terminal 200 of the filter 188 is coupled to a second shield 202 of the second length of coaxial cable 196 at the second end 198 thereof. The second length of coaxial cable 196 serves as a feedline portion of the dipole reception antenna 204. The dipole antenna 204 also comprises a first pole portion 206 formed from a first length of conductor, for example a uniaxial conductor, and a second pole portion 208 formed from a second length of conductor, for example another uniaxial conductor. At the first end thereof 197, the second core 194 of the feedline portion 196 is coupled to one end of the first pole portion 206 via a balun 205 and the second shield 202 of the feedline portion 196 is coupled to one end of the second pole portion 208 via the balun 205. Together, the separating cable 170 and the feedline portion 196 constitute an antenna feedline. In use, the poles of the dipole antenna 204 are arranged by a user to extend substantially or approximately away from each other to ensure proper operation of the antenna arrangement apparatus 162.

A first length of the first pole 206 corresponds to a quarter of a wavelength (λ/4) of a signal the receipt of which is desired, for example a broadcast signal, such as an FM signal comprising RDS-TMC data. Consequently, in this example, the length of the first pole portion 206 is about 75 cm. Similarly, a second length of the second pole 208 corresponds to a quarter of a wavelength (λ/4) of the signal the receipt of which is desired. Consequently, in this example, the dipole antenna 204 is symmetric, the length of the second pole portion 208 also being about 75 cm.

In another embodiment, the dipole antenna 204 is asymmetric, the first length of the first pole portion 206 and the second length of the second pole portion 208 being different proportions of the wavelength (λ).

From the above examples, it should be appreciated that any suitable reception antenna can be employed and that other embodiments, employing other types of antenna coupled to the separating cable 170 via the filter 188, are envisaged. For example, in another embodiment, the feedline portion 196 need not be employed and the first and second pole portions 206, 208 can be coupled to the filter 188 without the need for disposal of the feedline portion therebetween.

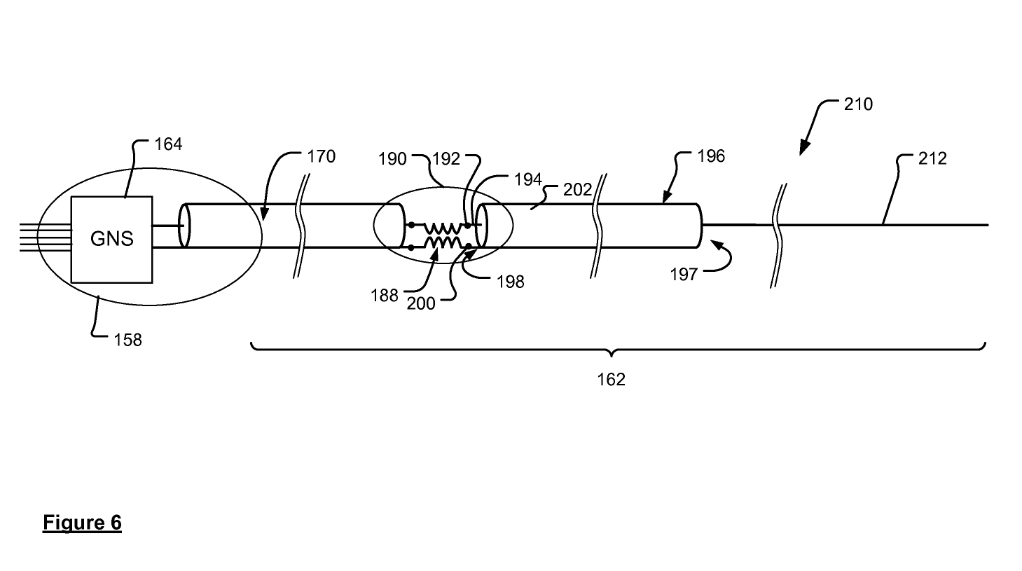

In another embodiment (FIG. 6), a resonant feedline dipole antenna 210 is coupled to the separating cable 170 via the filter 188. In this respect, the tuner 164 is coupled to the separating cable 170 and the separating cable 170 is coupled to the filter 188 in the same manner to that already described above in relation to the previous examples. Also, the filter 188 is of a like construction to that described above in relation to the previous embodiments. Consequently, for the sake of simplicity and conciseness of description, the connectivity between the tuner 164, the separating cable 170 and the filter 188, and the nature of the filter 188, will not be described again in further detail in relation to this example.

The dipole antenna 210 comprises a first pole portion 212 formed from a length of conductor, for example a uniaxial conductor, and the second length of coaxial cable 196 having the second shield 202. In this example, the second length of coaxial cable 196 serves as a feedline portion in a like manner to that described above in relation to the previous example, but also constitutes a second pole portion of the reception antenna 210. Also, as in the case of the previous example, together the feedline portion 196 and the separating cable 170 constitute an antenna feedline. The second core 194 of the second length of coaxial cable 196 is used as the uniaxial electrical conductor forming the first pole portion 212. However, the skilled person should appreciate that a separate, unshielded, conductor can be used and coupled to the second core 194 of the second length of coaxial cable 196, for example by soldering. As can be seen from FIG. 6, the resonant feed-line dipole reception antenna 210 is end-fed. In this respect, the second core 194 of the second length of coaxial cable 196 is coupled to the third terminal 192 of the filter 188 and the second shield 202 of the second length of coaxial cable 196 is coupled to the fourth terminal 200 of the filter 188.

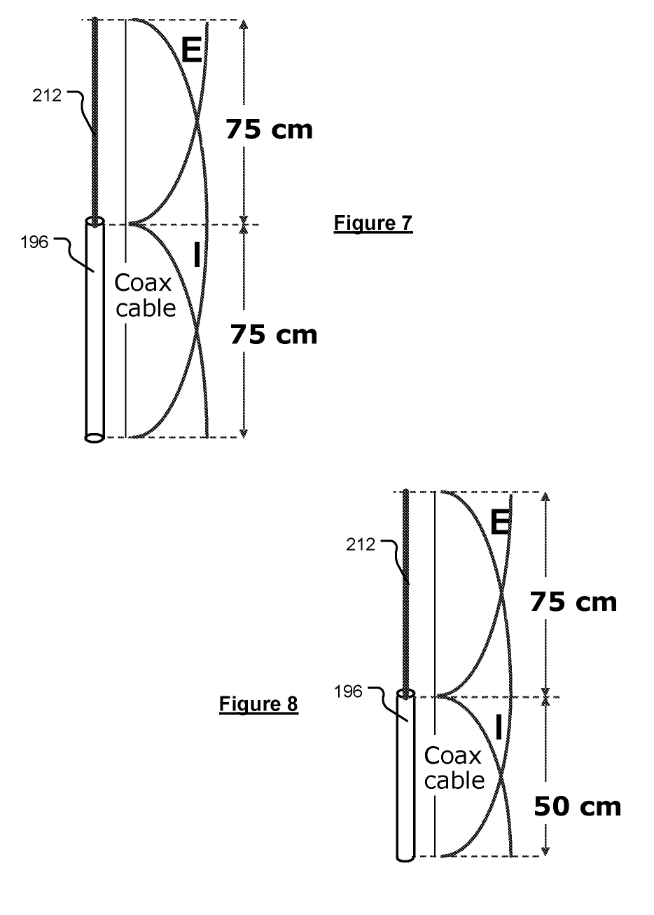

Turning to FIG. 7, a first length of the first pole 212 corresponds to a quarter of a wavelength (λ/4) of a signal the receipt of which is desired, for example a broadcast signal, such as an FM signal comprising RDS-TMC data. Consequently, in this example, the length of the first pole portion 212 is about 75 cm. Similarly, a second length of the second pole 196 corresponds to a quarter of a wavelength (λ/4) of the signal the receipt of which is desired. Consequently, in this example, the length of the second pole portion 196 is also about 75 cm.

In another embodiment (FIG. 8), the first length of the first pole portion 212 also corresponds to a quarter of the wavelength (λ/4) of the signal the receipt of which is desired, for example the broadcast signal, such as the FM signal comprising RDS-TMC data. Consequently, in this example, the length of the first pole portion 212 is again about 75 cm. However, the second length of the second pole portion 196 corresponds to a third of a wavelength (λ/3) of the signal the receipt of which is desired. Consequently, in this example, the length of the second pole portion 196 is about 50 cm. Hence, it can be seen that the length of the second pole 196 can correspond to between about one third of the wavelength and about one quarter of the wavelength.

Turning to FIG. 9 and in respect of the above embodiments, the separating cable 170 is coupled to the feedline 196 in the following manner. The first core 168 of the separating cable 170 is coupled to a first bridging contact 250, the first bridging contact 250 being coupled to the first terminal 184 of the filter 188. The first shield 176 of the separating cable 170 is coupled to a first shield contact 252 and a second bridging contact 254, the second bridging contact 254 being coupled to the second terminal 186 of the filter 188. The second core 194 of the feedline 196 is coupled to a third bridging contact 256, the third bridging contact 256 being coupled to the third terminal 192 of the filter 188. The second shield 202 of the feedline 196 is coupled to a second shield contact 258 and a fourth bridging contact 260, the fourth bridging contact 260 being coupled to the fourth terminal 200 of the filter 188. As mentioned above, the filter 188 is disposed within the housing 190, the second end 180 of the separating cable 170 and the distal end 198 of the feedline 196 extending into the housing. The housing comprises pull-relief parts 262 disposed therein to prevent damage to the connection between the separating cable 170 and the filter 188 and the feedline 196 and the filter 188 caused by the separating cable 170 and/or the feedline 196 being pulled. In order to reduce susceptibility of the antenna arrangement apparatus 262 to electromagnetic interference as a result of the coupling of the separating cable 170 to the feedline 196 via the filter 188, the loop area 264 of the bridging contacts is minimised and is, in this example, about 5 mm². However, the loop area 264 can be less than about 5 mm², for example less than about 3 mm². The bridging contacts can be provided by a Printed Circuit Board (PCB) and the filter 188 is, in this example, surface mounted to the PCB. In this embodiment, the second housing 190 is formed from a substantially rectangular-shaped plastics case that is ultrasonically welded closed. However, in another embodiment, the housing can be an encapsulation.

Referring back to FIG. 4, in operation, a first common-mode interference current component, i_{cm CLA}, flows from the CLA 150 to the docking station 140 and hence the navigation device 100, the first common-mode interference current component, i_{cm CLA}, being generated by the CLA 150. A second common-mode interference current component, i_{cm PND}, flows into the coupling cable 160 as a result of a parasitic capacitance existing between the ground 153 and the navigation device 100. Indeed, the second common-mode interference current component, i_{cm PND}, flows into the coupling cable 160 irrespective of whether or not the CLA 150 is coupled to the cigarette lighter of the vehicle and/or present. Additionally, a third common-mode interference current component, i_{cm EM,} is induced in the coupling cable 160 by electromagnetic radiation emanating from the navigation device 100. The presence of the filter 188 serves to isolate the resonant feed-line reception antenna 204, 210 from the above common-mode interference current components and so performance of the reception antenna 204, 210 is improved significantly, for example by about 20 dB. Furthermore, the separating cable 170 serves to distance the reception antenna 204, 210 from electromagnetic interference emitted by the navigation apparatus 100, thereby mitigating the third common-mode interference current component, i_{cm EM}, induced by the neighbouring navigation apparatus 100.

Indeed, the strength of the interference signals received by the antenna is increasingly attenuated with increase in length of the separating cable 170. Furthermore, the attenuation of interference signals provided by the separating cable 170 and the filter 188 is additive. At a frequency of 105.9 MHz, and ignoring the benefit provided by the filter 188, the attenuation of the common-mode interference signals provided by the separating cable 170 of the arrangement of FIG. 6 is shown in Table I, below:

TABLE I

| Length of | |
|---|---|
| separating | Interference |
| cable 170 | attenuation |
| (cm) | (dB) |
| 0 | 0 |
| 5 | 2.9 |
| 10 | 3.6 |
| 14 | 5.3 |
| 18 | 7.4 |
| 30 | 11.8 |

Without the filter 188, the coupling cable 160 and the separating cable 170 form a so-called “hot circuit” or are “EMC hot” and exhibit antenna-like behaviour. By provision of the filter 188, the distance at which conductors carry common-mode interference currents induced by electromagnetic radiation emissions, for example from the navigation device 100, is increased, namely the conductors of the reception antenna 204, 210 are the only conductors of the reception apparatus 156 into which common-mode interference currents can be induced by electromagnetic radiation emitted by the navigation device 100. Due to the distance of the reception antenna 204, 210 from the source of the electromagnetic radiation, namely the navigation device 100, and the attenuation of the power of the electromagnetic radiation with distance from the navigation device 100, the amount of induced common-mode interference current that flows in the reception antenna 204, 210 is minimised considerably.

A differential-mode current signal generated in the reception antenna 204, 210 is therefore received, with reduced common-mode interference current components, by the receiver 164 and demodulated and decoded before communication to the navigation device 100, via the input port 125 thereof, for use by the traffic data processing module 136 of the application software 134. The differential-mode current is almost unaffected by the presence of the common-mode filter 188.

It should be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above embodiments have been described in relation to reception of FM signals, particularly RDS-TMC signals, the skilled person should appreciate that the above embodiments can be used in respect of other applications, for example Digital Audio Broadcast (DAB) reception, such as Transport Protocol Experts Group (TPEG) data streams. Indeed, the skilled person should appreciate that the antenna arrangement apparatus 162 can be used to receive signals bearing audio information, for example FM audio signals. Consequently, the antenna arrangement apparatus can be used in connection with FM radio applications, for example FM radio applications used in relation to other electronic devices, such as communications devices. One suitable example is a mobile telephone handset comprising an integrated FM receiver or coupled to an FM receiver module.

By way of further example, it should be appreciated that although the above embodiments have been described in the context of a navigation apparatus, the techniques described herein are not only applicable to navigation apparatus, but also to any other electronic apparatus or accessories therefor capable of receiving RF signals, for example RDS or RDBS data signals on an FM channel. Examples of suitable devices include mobile telephones or media players, such as music players, in particular but not exclusively MP3 players or accessories therefor.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. An antenna arrangement apparatus comprising:
a reception antenna comprising a first length of coaxial cable, constituting a first feedline portion and a pole portion, the first length of coaxial cable being coupled at a first end thereof to the pole portion;
a common-mode filter; and
a length of separating cable coupled to the reception antenna; wherein
the length of separating cable has a proximal end with respect to the reception antenna, the proximal end being coupled to the reception antenna via the common-mode filter.

2. (canceled)

3. (canceled)

4. An apparatus as claimed in claim 1, wherein the separating cable comprises a second length of coaxial cable and constitutes a second feed line portion.

5. An apparatus as claimed in claim 4, wherein the first feedline portion is coupled at a second end thereof to the length of separating cable via the common-mode filter.

6. An apparatus as claimed in claim 1, wherein the reception antenna is a resonant dipole antenna in which a first pole comprises the pole portion and a second pole comprises the first length of coaxial cable.

7. An apparatus as claimed in claim 6, wherein a length of the first pole portion corresponds to about a quarter of a predetermined wavelength for a Radio-Frequency signal to be received.

8. An apparatus as claimed in claim 6, wherein a length of the second pole portion corresponds to between about a third of a predetermined wavelength and about a quarter of the predetermined wavelength for a Radio-Frequency signal to be received.

9. An apparatus as claimed in claim 6, further comprising a length of uniaxial electrical conductor serving as the first pole portion.

10. An apparatus as claimed in claim 6, wherein the first length of coaxial cable comprises a shield, the shield serving as the second pole portion.

11. (canceled)

12. An apparatus as claimed in claim 1, wherein the common-mode filter has a common-mode impedance of between about 1000 Ω and about 4000 Ω in the frequency band of the signal of interest.

13. An apparatus as claimed in claim 12, wherein the common-mode filter has a common mode impedance of about 2200 Ω in the frequency band of the signal of interest.

14. An apparatus as claimed in claim 1, wherein the separating cable is at least about 5 cm in length.

15. An apparatus as claimed in claim 1, wherein the separating cable is less than about 30 cm in length.

16. An apparatus as claimed in claim 1, wherein the common-mode filter is a bifilar coil.

17. (canceled)

18. (canceled)

19. (canceled)

20. A reception apparatus comprising:
the antenna arrangement apparatus as claimed in claim 1; and
a tuner coupled to a distal end of the separating cable.

21. An apparatus as claimed in claim 20, wherein the tuner is a Frequency Modulation tuner.

22. An apparatus as claimed in claim 20, wherein the tuner is a Radio Data System Traffic Message Channel tuner.

23. An apparatus as claimed in claim 20, further comprising a coupling cable for communicating data decoded by the tuner to a device.

24. A portable navigation device comprising the antenna arrangement apparatus or the reception apparatus as claimed in claim 1.

25. (canceled)
